(19) United States
(12) Patent Application Publication
(10) Pub. No.: US 2023/0149132 A1
(43) Pub. Date: May 18, 2023

(54) ORTHODONTIC APPLIANCE FOR MALOCCLUSION CORRECTION

(71) Applicant: Facial Gear LLC, Glenview, IL (US)

(72) Inventors: Marinho Del Santo, JR., Brookfield, WI (US); Neil Warshawsky, Glenview, IL (US)

(73) Assignee: Facial Gear LLC, Glenview, IL (US)

(21) Appl. No.: 17/987,146

(22) Filed: Nov. 15, 2022

Related U.S. Application Data
(60) Provisional application No. 63/361,020, filed on Nov. 15, 2021.

(51) Int. Cl. A61C 7/36

(52) U.S. Cl. CPC A61C 7/36

(57) ABSTRACT

An orthodontic device having an anchor plate with holes for receiving screws to attach the anchor plate to the patient's maxilla or mandible, and a jaw displacer with a spring exerting an axial biasing force to reposition the mandible for malocclusion correction. A ball-and-socket connector is used to removably attach one end of the jaw displacer to the anchor plate. A second connector removably secures the second end of the jaw displacer to the other of the patient's mandible and maxilla.

### RELATED APPLICATION

The present application is based on and claims priority to the Applicant's U.S. Provisional Patent Application 63/361,020, entitled “Del Santo Orthodontic Appliance, A New Device for Class II Malocclusion Correction,” filed on Nov. 15, 2021.

### BACKGROUND OF THE INVENTION

Field of the Invention. The present invention generally relates to the field of orthodontic appliances. More specifically, the present invention discloses an orthodontic appliance for malocclusion correction by addressing skeletal dysplasias.

Statement of the Problem. Temporary anchorage devices (or TADs) have been widely used in orthodontics as a simplifying adjunct to classic treatment protocols. Mini-screws and mini-plates are temporarily screwed into predetermined facial bones as anchors to allow orthopedic and orthodontic movements that were difficult or impossible by prior anchorage methods. The surgical placement of mini-plates generally provokes minimal inconvenience for the patient and has been associated with few adverse events. Compared with other dental interventions, this approach is usually perceived as better than headgears, nearly always better than braces, better or equivalent to regular orthodontic extractions, and equal to or worse than regular cavity restorations.

The interest of orthodontists in TADS to correct severe skeletal problems, such as vertical discrepancies, Class III midface deficiencies, and some Class II and Class III skeletal deficiencies, has increased significantly. Vertical facial dysmorphologies and open-bite skeletal scenarios have been addressed by the intrusion of posterior teeth using TADs. The primary purpose of such a therapeutic approach is to allow forward mandibular rotation to improve the facial profile and maintain considerable long-term stability. In Class III subjects, midface skeletal deficiencies have been successfully treated with TADs combined with light forces from continuous intermaxillary elastic treatment, most likely precluding adverse dentoalveolar compensations. The skeletal changes promoted by Class III TADs result in forward movement of the entire maxillary bone. These effects are not limited to the alveolar bone but extend up to the surrounding bone structures.

TADs can also be used for Class II correction to promote upper molar distalization as traditional orthodontic distalizers. For example, U.S. Patent App. Pub. No. 2021/0205119 (De Clerck) discloses a jaw displacement system with a TAD for advancing the mandible. Another example is shown in FIG. 2 of U.S. Patent App. Pub. No. 2010/0139666 (Bonnaure). The prior art also includes similar mandibular advancement devices attached directly to the mandible and maxilla using bone screws, as shown for example in U.S. Patent App. Pub. No. 2008/0176185 (Williams), U.S. Patent App. Pub. No. 2006/0172251 (Voudouris), and WO 2010/037195 (Blanc et al.)

In addition, telescoping Herbst appliances have been used for many years to reposition the mandible, as shown for example in U.S. Pat. No. 9,144,474 (Faust et al.). These appliances are typically attached to the upper and lower archwires, or secured to dental accessories or crowns. Herbst appliances are challenged by various forces and moments during mandibular shifting, particularly in lateral movements of the mandible. In response, Herbst appliances typically include holes or eyelets at either end of the piston/tube mechanism to enable the appliance to pivot about screws installed into the maxilla and mandible as the jaw moves. If the Herbst appliance is attached to the archwires, a further degree of freedom can be provided.

The Flip-Lock® Herbst appliance marketed by TP Orthodontics, Inc. of La Porte, Indiana, features two ball hinges extending from brackets mounted respectively on selected upper and lower teeth that removably engage corresponding sockets on the ends of the piston/tube mechanism of the appliance. These ball hinges accommodate a wider range of three-dimensional movement of the mandible.

The prior art also includes the use of headgears for treatment of skeletal or dental malocclusions. Craniofacial growth is an important area in the orthodontic profession. It has been studied for about 120 years and is currently much better understood. Headgears were the classic orthodontic appliance to address maxillary growth. The most interesting findings are that headgears also address mandibular growth, mainly by promoting mandibular rotation. The bottom line is that mandibular rotation is the main goal in correcting hard and soft tissue facial profiles.

Headgears were very popular among orthodontists for about a century but largely lost popularity in recent decades. This happened not because they do not work but mainly because patients do not want to wear them. The present appliance can be viewed as an analog of the headgear. Indeed, the present appliance has a much greater potential than headgears because: (1) it does not present the aesthetic or discomfort drawbacks associated with headgears; and (2) it can apply continuous light continuous force (that is ideal in orthodontics and dentofacial orthopedics) as headgears are unable to do consistently.

Solution to the Problem. None of the prior art references discussed above show an orthodontic appliance for malocclusion correction having the combination of elements of the present appliance. In particular, the present appliance combines an anchor plate to secure the appliance to the patient's maxilla or mandible with a ball-and-socket connector for removably attaching a jaw displacer. This allows secure, straightforward, and efficient engagement. Consequently, the mechanical outcomes are highly predictable.

This provides an appliance to correct dentofacial skeletal dysmorphologies presented by skeletal Class II and Class III malocclusion subjects. The present appliance promotes potential therapeutic benefits for late mixed dentition patients (about 9 to 12 year old children) and permanent dentition patients (about 13 to 18 year old adolescents).

### SUMMARY OF THE INVENTION

This invention provides a craniofacial skeletal appliance having an anchor plate with holes for receiving screws to attach the anchor plate to the patient's maxilla or mandible, and a jaw displacer with a spring exerting an axial biasing force to reposition the mandible for malocclusion correction. For example, the jaw displacer can apply a pushing force in Class II setups or a pulling force in Class Ill setups. A ball-and-socket connector is used to easily removably attach one end of the jaw displacer to the anchor plate. A second connector removably secures the second end of the jaw displacer to the other of the patient's mandible and maxilla.

These and other advantages, features and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified side view of a skull with a possible embodiment of the present appliance extending from the maxilla 10 and to the mandible 20, when the mandible 20 is in the closed position.

FIG. 2 is a simplified side view corresponding to FIG. 1 with the mandible 20 in an open position.

FIG. 3 is a side view of the anchor plate 30.

FIG. 4 is a detail axonometric view of the socket connector 40 extending from the lower arm 32 of the anchor plate 30.

FIG. 5 is a side cross-sectional view of the socket connector 40 with a ball connector 60 extending from the jaw displacer 50 seated in its socket 42.

FIG. 6 is a cross-sectional view of the jaw displacer 50.

FIG. 7 is a side view of an alternative embodiment of the anchor plate 30.

FIG. 8 is a side view of an alternative embodiment of the present appliance to protract the mandible to treat Class II malocclusion.

FIG. 9 is a detail side view of the alternative embodiment of the appliance corresponding to FIG. 8.

### DETAILED DESCRIPTION OF THE INVENTION

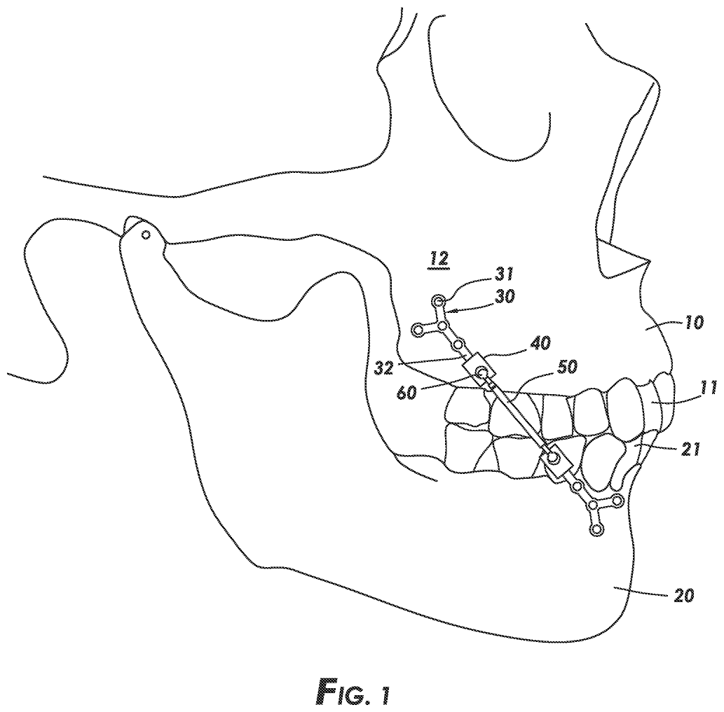

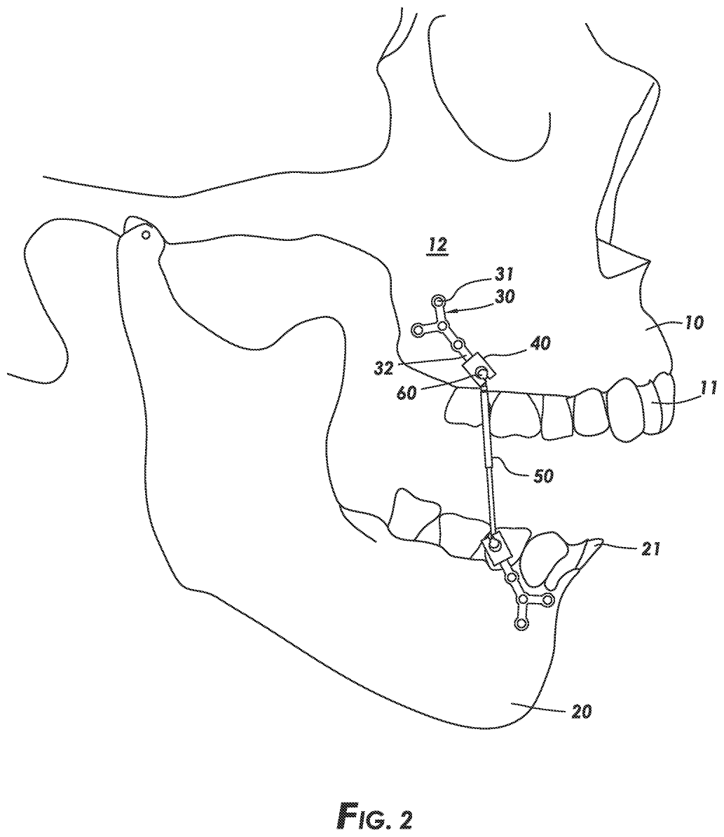

FIG. 1 shows a simplified side view of a skull with the present appliance extending between a patient's maxilla 10 and mandible 20, with the mandible 20 in the closed position. FIG. 2 is a corresponding side view with the mandible 20 in an open position. The primary components of the present appliance include an anchor plate 30 with holes 31 for receiving screws to attach the anchor plate 30 to the patient's maxilla 10 (e.g., at the zygomaticomaxillary buttress) or mandible 20 (e.g., upper lateral skeletal chin), and a jaw displacer 50 with a spring 52 exerting an axial biasing force to reposition the mandible 20 for malocclusion correction. For example, the jaw displacer can apply a pushing force for Class II malocclusion correction or a pulling force in Class III malocclusion correction. A ball-and-socket connector 40, 60 is used to removably attach one end of the jaw displacer 50 to the anchor plate 30. For example, this connection between the ball 60 and socket 40 can be a snap fit. A second connector removably secures the second end of the jaw displacer 50 to the other jaw (maxilla 10 or mandible 20).

FIG. 3 is a front view of the anchor plate 30. In the embodiment of the present invention shown in FIGS. 1 and 2, the anchor plate 30 is attached to the maxilla 10. Preferably, the anchor plate 30 is made of titanium or a similar biocompatible material, and is secured by screws to the zygomatic buttress, ahead of the zygomaticomaxillary suture and below the zygomatic arch 12. The anchor plate 30 also includes an arm 32 extending occlusally toward the adjacent end of the jaw displacer 50. A ball-and-socket 40, 60 connector at the distal end of the arm 32 removably attaches the anchor plate 30 to the end of the jaw displacer 50, as will be discussed in greater detail below.

FIG. 6 is a cross-sectional view of one possible embodiment of the jaw displacer 50. The jaw displacer 50 extends along an axis between opposing first and second ends, and is equipped with a spring 52 exerting an axial force between the ends. A pushing force is designed to correct Class II malocclusion (i.e., to push the maxilla 10 and mandible 20 apart). A pulling force is designed to correct Class III malocclusions (i.e., by pulling the maxilla 10 and mandible 20 toward each other). This biasing force is transmitted via the connectors at each end of the jaw displacer 50 and the anchor plate(s) 30. The internal mechanism of the jaw displacer 50 can be generally similar to a conventional Herbst appliance with two telescoping tubes 54 and 56 containing a spring 52 as shown in FIG. 6. Alternatively, the jaw displacer 50 could have a generally cylindrical tube containing a metallic rod with an internal retraction or protraction coil spring 52, mechanically working like a piston. For example, the spring 52 can be made of a super-elastic nickel-titanium alloy and act in either tension (for Class III correction) or compression (for Class II correction).

Several possible types of springs 52 can be used in the jaw displacer 50. For Class II malocclusions, the maxilla 10 must be addressed backward and the mandible 20 must be addressed forward. In this case, the jaw displacer 50 can be equipped with an active compressed close coil spring to push. In contrast, for Class III malocclusions, the maxilla 10 must be addressed forward and the mandible 20 must be address backward. In that case, the jaw displacer can be equipped with an active stretch open coil spring to pull. However, other configurations of the jaw displacer 50 and types of springs could be readily substituted.

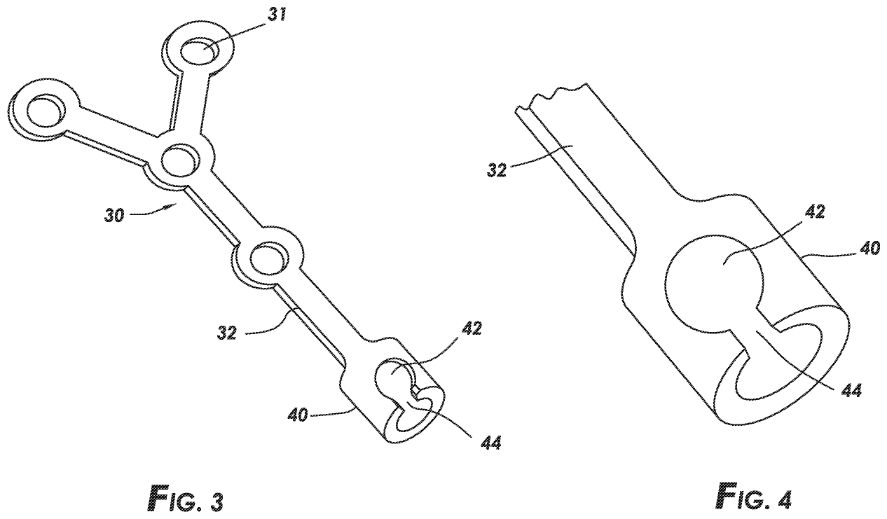

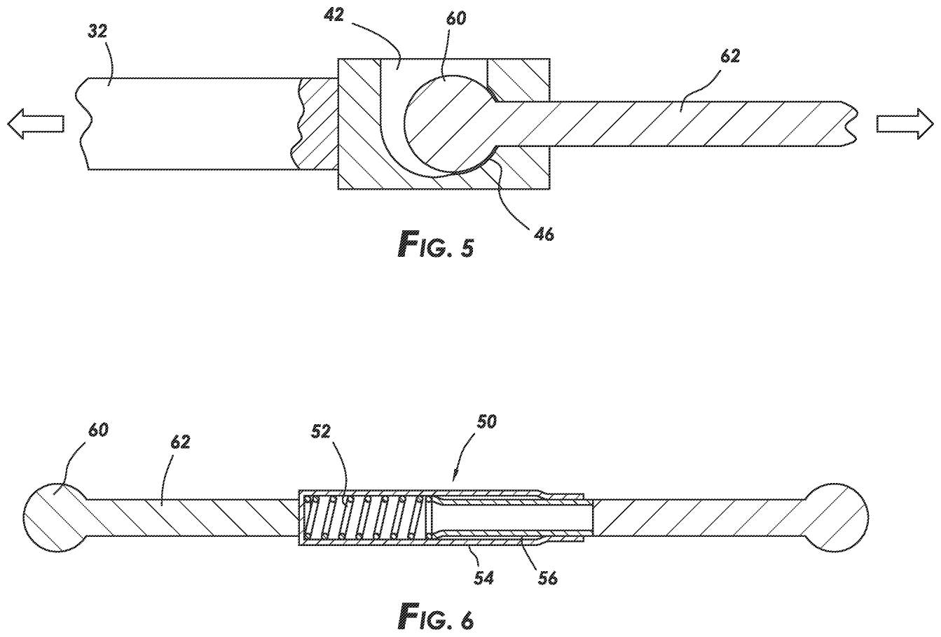

Returning to FIGS. 1 and 2, the ball-and-socket connector 40, 60 includes a socket connector 40 extended from the arm 32 of the anchor plate 30 having a labial aspect with an opening 42. FIG. 4 is a detail axonometric view of this socket connector 40. As shown in FIGS. 5-6, a rod 62 extends from the first end of the jaw displacer 50 with a ball or enlarged head 60 at its distal end. The enlarged head 60 is complementary to the opening 42 in the socket 40, so that the socket 40 receives and removably engages the enlarged head 60 as shown in FIG. 5. In other words, the rod 62 and enlarged head 60 form a “ball connector” for removably engaging the socket connector 40 as shown in FIGS. 1, 2 and 5. Preferably, the socket 40 removably engages the enlarged head 60 with a snap fit.

The terms “ball” and “enlarged head” should be broadly construed to include any type of enlarged head extending radially outward from the end of the rod 62. For example, the ball could be generally spherical, oval, etc. Morphologically and mechanically, the shape of the ball matches the shape of the socket. Preferably, the socket connector 40 includes a defined recess 46 for seating and retaining the ball 60 so that the biasing force exerted by the spring 52 tends to hold the ball 60 in place as shown in FIG. 5.

In addition, the socket connector 40 includes a slot or gap 44 in its peripheral wall as illustrated in FIG. 4 to accommodate the rod 62. This enables the ball 60 to be initially inserted into the socket connector 40 in a non-axial orientation. The ball connector can then be pivoted into axial alignment with the socket connector 40 and the arm 32 of the anchor plate 30. The socket connector 40 also allows a degree of rotation of the ball connector in the socket, as shown by comparing FIGS. 1 and 2.

As previously discussed, a ball-and-socket connector 40, 60 is employed to removably attach the arm 32 of the anchor plate 30 to the first end of the jaw displacer 50 as shown in FIGS. 1 and 2. It should be understood that the relative positions and orientations of the components of this ball-and-socket connector 40, 60 and the jaw displacer 50 can be readily reversed depending on whether the appliance is used to advance or retract the mandible 20. In treatment of Class II malocclusion, the spring 52 and jaw displacer 50 are configured to exert a biasing force that tends to advance or protract the mandible 20 relative to the maxilla 10. In contrast, in treatment of Class III malocclusion, the spring 52 and jaw displacer 50 exert a biasing force to retract the mandible 20.

For example, FIG. 6 shows a spring 52 exerting a biasing force to advance the mandible 20 with respect to the maxilla 10. This would typically be used to treat a patient having Class II malocclusion. In contrast, the configuration of the spring 52 within the jaw displacer 50 could be reversed, so that the spring 52 exerts a biasing force to retract the mandible 20 for treating a patient with Class III malocclusion.

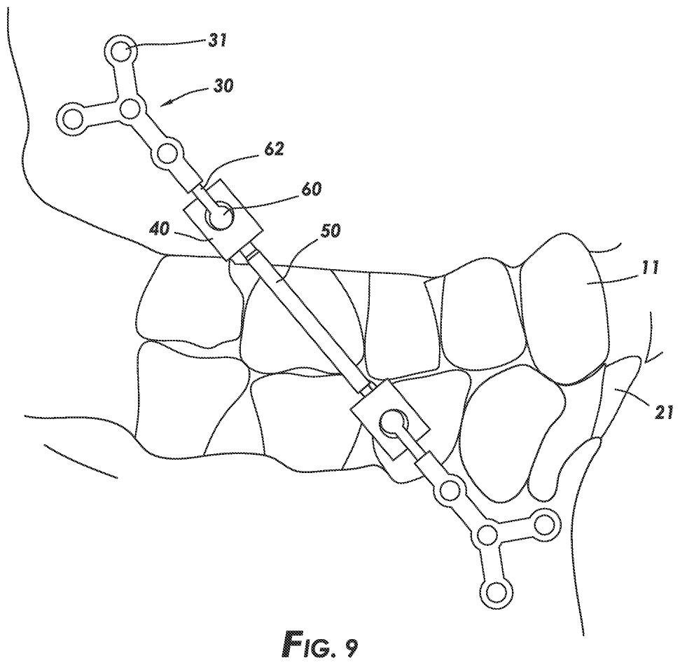

Similarly, the relative positions of the components of the ball-and-socket connectors 40, 60 can be reversed. In particular, this may be advantageous based on the direction of the spring force to keep the ball 60 seated in the socket 40. The embodiment of the present appliance shown in FIGS. 1-2 has the socket connector 40 extending from the anchor plate 30 and the ball connector 60 extending from the end of the jaw displacer 50. In contrast, FIGS. 8 and 9 depict an alternatively embodiment in which socket connectors 40 extend from the ends of the jaw displacer 50 and ball connectors 60 extend from the anchor plates 30.

A second connector removably secures the second end of the jaw displacer 50 to the other of a patient's mandible 20 or maxilla 10. In the embodiment shown in the accompanying figures, this second connector is another ball-and-socket connector that attaches the second, mandibular end of the jaw displacer 50 to a second anchor plate as shown in FIGS. 1, 2 and 8. Alternatively, the second end of the jaw displacer 50 could be secured to the mandible 20 by conventional means, such as a hook, a screw or an eyelet attached to an orthodontic bracket, a post or a dental crown. In yet another alternative embodiment, a ball-and-socket connector could be used at the mandibular end of the jaw displacer 50, and conventional means (such as an orthodontic archwire with a hook, a screw, or an eyelet attached to an orthodontic bracket, a post or a dental crown) would be used to secure the maxillary end of the jaw displacer 50. Attachment by means of one ball-and-socket connector (i.e., at one end of the jaw displacer 50) is sufficient for easy delivery of the desired mechanics. Moreover, ball-and-socket connectors 40 and 60 could be used at either or both ends of the jaw displacer 50. Similarly, anchor plates 30 can be used to secure the appliance to either or both of the maxilla and mandible. The versatility of the appliance design and mechanism is evident.

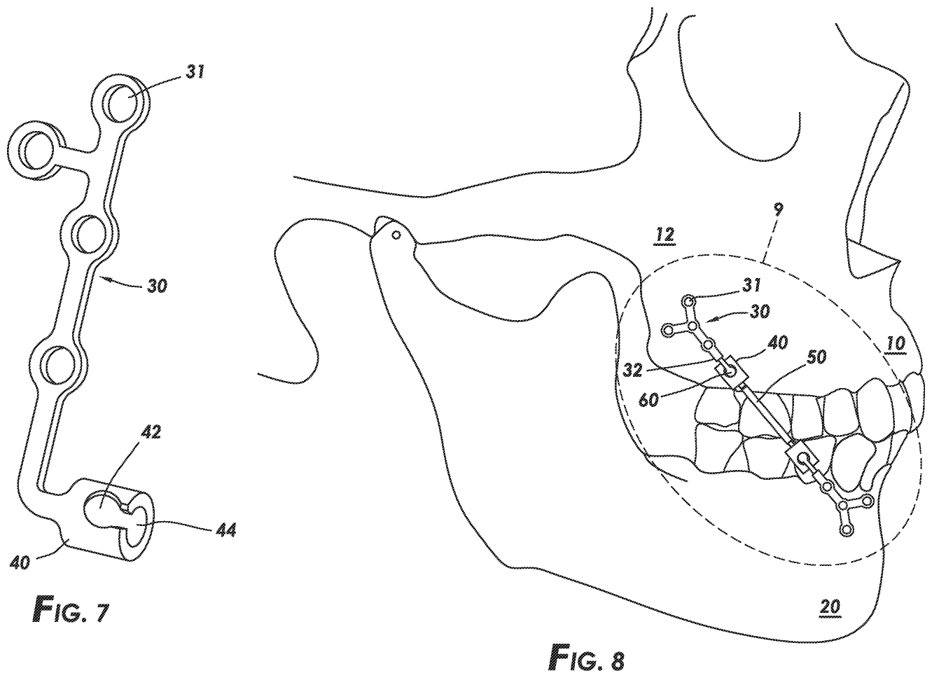

FIGS. 3 and 7 show two alternative embodiments of the anchor plate 30 for: (1) hyperdivergent facial phenotype patients (high-pull traction); and (2) hypodivergent facial type patients (low-pull traction), respectively. Both embodiments can be manufactured with the same ball-and-socket connector and jaw displacer mechanisms. The difference between both is the shape of the anchor plate 30 as shown in FIGS. 3 and 7.

The high-pull embodiment (FIG. 3) is angulated regarding the “zero momentum” upward and backward maxillary growth, going through its center of mass (i.e., “zero line”). The zero line is angulated about 50 degrees regarding the true horizontal line (Sella-Nasion cranial base plane minus 7 degrees, known as SN-7). Thus, it crosses the zygomaticomaxillary suture plane (posterior nasal spine to anterior orbital ridges) at the middle of the radiographic zygomaticofacial ridges.

“Zero line” angulation can be used to define theoretical vertical classes. For example, if the high-pull embodiment of the present device is angulated clockwise regarding the zero line, it provides a greater vertical pull, increasing the maxillary occlusal plane clockwise rotation. If the high-pull embodiment is angulated counterclockwise regarding the zero line, it gives a lesser vertical pull, decreasing the clockwise rotation of the maxillary occlusal plane.

In hyperdivergent patients, upward posterior inclination of the maxillary occlusal plane promoted by the high-pull embodiment of the present device tends to create leeway space between the upper and lower molars. Potentially, such leeway space allows favorable counterclockwise mandibular rotation, with consequent chin anterior projection. Installation of an anchored banded mandibular lingual arch in these patients is typically required in order to avoid mandibular molars extrusion and allow mandibular counterclockwise rotation. The bands can be connected to bilateral vestibular single screws (installed between the mesial root of the first lower molars and the root of the second premolars or at the mandibular buccal shelf). This mandibular skeletal anchorage might promote absolute (active) or relative intrusion of the lower molars (avoiding their natural eruption) of about 0.1 mm/month (roughly 1 mm per year). Unfavorable eruption of the lower molars can derail mandibular counterclockwise rotation since the potential favorable leeway space between upper and lower molars created by the appliance high-pull traction is taken by an uncontrolled lower molar extrusion/eruption.

In hypodivergent patients (FIG. 7), the low-pull horizontal angulation would provide active leverage between the upper and lower molars. Clockwise mandibular rotation and a favorable decrease in chin projection are expected. This is a major goal for Class III patients (excessive anterior chin projection). The expected downward positioning of the chin is slightly greater than its backward positioning.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. An orthodontic device for malocclusion correction comprising:
an anchor plate with holes for receiving screws to attach the anchor plate to one of a patient's maxilla and mandible;
a jaw displacer extending along an axis between opposing first and second ends with a spring exerting an axial force between the ends;
a first connector for removably attaching the first end of the jaw displacer to the anchor plate, said first connector having:
(a) a rod extending from one of the anchor plate and the first end of the jaw displacer to a distal end, and having an enlarged head at the distal end of the rod; and
(b) a socket having an opening for receiving and removably engaging the enlarged head, wherein the socket extends from the other of the anchor plate and the first end of the jaw displacer; and
a second connector for removably securing the second end of the jaw displacer to the other of a patient's mandible and maxilla;
wherein the spring of the jaw displacer exerts a biasing force via the first connector, second connector and anchor plate to reposition a patient's mandible with respect to the maxilla for malocclusion correction.

2. The orthodontic device of claim 1 wherein the anchor plate is attached to a patient's maxilla.

3. The orthodontic device of claim 2 wherein the anchor plate is attached to a patient's maxilla below the zygomatic arch.

4. The orthodontic device of claim 1 wherein the anchor plate is attached to a patient's mandible.

5. The orthodontic device of claim 1 wherein the anchor plate further comprises an arm extending occlusally toward the first end of the jaw displacer, and the first connector is secured to the arm.

6. The orthodontic device of claim 1 wherein the socket removably engages the enlarged head with a snap fit.

7. The orthodontic device of claim 1 wherein the socket further comprises a slot leading to the opening for receiving the rod.

8. The orthodontic device of claim 1 wherein the jaw displacer further comprises a telescoping rod and cylinder containing the spring.

9. The orthodontic device of claim 1 wherein the spring exerts a biasing force to protract the mandible for treatment of class II malocclusion.

10. The orthodontic device of claim 1 wherein the spring exerts a biasing force to retract the mandible for treatment of class Ill malocclusion.

11. The orthodontic device of claim 1 wherein the second connector comprises:
a rod extending from one of the second anchor plate and the second end of the jaw displacer to a distal end, and having an enlarged head at the distal end of the rod; and
a socket having an opening for receiving the enlarged head and a recess for removably engaging the enlarged head; wherein the socket extends from the other of the anchor plate and the second end of the jaw displacer.

12. An orthodontic device for malocclusion correction comprising:
an anchor plate with holes for receiving screws to attach the anchor plate to a patient's maxilla;
a jaw displacer extending along an axis between opposing first and second ends with a spring exerting an axial force between the ends;
a first connector for removably attaching the first end of the jaw displacer to the anchor plate, said first connector having:
(a) a rod extending from one of the anchor plate and the first end of the jaw displacer to a distal end, and having an enlarged head at the distal end of the rod; and
(b) a socket having an opening for receiving the enlarged head and a recess for removably engaging the enlarged head; wherein the socket extends from the other of the anchor plate and the first end of the jaw displacer; and
a second connector for removably securing the second end of the jaw displacer to a patient's mandible;
wherein the spring of the jaw displacer exerts a biasing force to reposition a patient's mandible with respect to the maxilla for malocclusion correction and to seat the enlarged head in the recess of the socket.

13. The orthodontic device of claim 12 further comprising a second anchor plate removably securing the second connector to a patient's mandible.

14. The orthodontic device of claim 12 wherein the second connector comprises:
a rod extending from one of the second anchor plate and the second end of the jaw displacer to a distal end, and having an enlarged head at the distal end of the rod; and
a socket having an opening for receiving the enlarged head and a recess for removably engaging the enlarged head; wherein the socket extends from the other of the anchor plate and the second end of the jaw displacer.

15. The orthodontic device of claim 12 wherein the anchor plate is attached to a patient's maxilla below the zygomatic arch.

16. The orthodontic device of claim 12 wherein the anchor plate further comprises an arm extending occlusally toward the first end of the jaw displacer, and the first connector is secured to the arm.

17. The orthodontic device of claim 12 wherein the socket further comprises a slot leading to the opening for receiving the rod.

18. The orthodontic device of claim 12 wherein the jaw displacer further comprises a telescoping rod and cylinder containing the spring.

19. The orthodontic device of claim 12 wherein the spring exerts a biasing force to protract the mandible for treatment of class II malocclusion.

20. The orthodontic device of claim 12 wherein the spring exerts a biasing force to retract the mandible for treatment of class Ill malocclusion.
